(19) United States
(12) Patent Application Publication
(10) Pub. No.: US 2010/0218665 A1
(43) Pub. Date: Sep. 2, 2010

(54) Sensor for an acoustic instrument

(76) Inventor: Bradley Clark, Victoria (AU)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(21) Appl. No.: 11/991,254

(22) PCT Filed: Aug. 28, 2006
(86) PCT No.: PCT/AU2006/001248

§ 371 Date: Aug. 22, 2008

(30) Foreign Application Priority Data
Aug. 30, 2005 (AU) 2005904741

(51) Int. Cl. G10H 3/18

(52) U.S. Cl. 84/731

(57) ABSTRACT

A sensor for detecting vibrations in a soundboard of an acoustic instrument, such as an acoustic guitar. The sensor includes a brace means mounted to the soundboard of the acoustic instrument. The sensor further includes a transducer mounted on the brace means. The brace means detects vibrations in a region of the soundboard in engagement with the brace means and transmits the detected vibrations to the transducer. The transducer subsequently generates an electrical output signal representing vibrations detected by the transducer. The brace means includes a plurality of brace members to which the transducer is mounted.

### RELATED APPLICATIONS

This application claims priority to PCT Application No. PCT/AU2006/001248 filed Aug. 28, 2006, and Australian Application No. 2005904741 filed Aug. 30, 2005, the disclosures of which are hereby incorporated by reference in their entireties.

### FIELD OF THE INVENTION

The present invention relates to a sensor for an acoustic instrument, and in particular to a sensor for detecting vibrations in a panel of the instrument. The sensor is especially suited to the detection of vibrations in a panel, such as a front face or soundboard, of a stringed musical instrument, such as an acoustic guitar, and it will therefore be convenient to describe the invention in relation to that example application. It should be understood however that the invention is intended for broader application and use.

### BACKGROUND OF THE INVENTION

A stringed instrument such as an acoustic guitar includes a body or resonant cavity having (i) a front panel, often referred to as the face or soundboard, (ii) a back panel and (iii) side walls extending between the soundboard and back panel. To provide structural rigidity the panels and side walls, in particular the soundboard, are braced or strutted with thin sections of timber. A neck, carrying a finger board, projects from the body and strings are stretched between a “nut” at the head end of the finger board and a “saddle” supported by a bridge attached to the soundboard of the instrument. The strings oscillate, when plucked or strummed, between the nut and the saddle.

In an acoustic guitar, these oscillations are transmitted mechanically as vibrations to the soundboard of the instrument, and hence to the resonant cavity, including the back panel and side walls. These vibrations are then transmitted to the surrounding air, predominately by the soundboard of the instrument but also by the back panel and side walls, and to some extent also by the strings directly.

In the past, acoustic guitars have generally been recorded or amplified using a transducer, for example a piezoelectric transducer, situated between the bridge and the saddle of the instrument, i.e. immediately under the strings. The response achieved by such an arrangement is predominately the reproduction of vibrations of the strings according to how they are stretched between the nut and the saddle of the instrument, and of course the performance or playing of the instrument. However, as the piezoelectric transducer in this arrangement is not in intimate contact with the soundboard or face, back and side walls of the acoustic guitar, the vibrations of these components are not reproduced to any significant extent.

There have been attempts in the past to address this problem by directly sensing the vibrations in the soundboard or face of the instrument with a transducer mounted onto the soundboard. However, such attempts have met with limited success because the transducer can only sense vibrations over the region of the soundboard in direct contact with transducer. This is due to the poor ability of vibrations to travel through the relatively soft wood from which soundboards are constructed. Attempts have been made to increase the region of the soundboard sensed by the transducer by increasing the surface area of the transducer in contact with the soundboard. However, such attempts have led to the vibrations in the soundboard being overly restrained to the detriment of the sound produced.

Accordingly it would be desirable to provide a device which overcomes or ameliorates at least one of the above described problems of the prior art.

Any discussion of documents, devices, acts or knowledge in this specification is included to explain the context of the invention. It should not be taken as an admission that any of the material formed part of the prior art base or the common general knowledge in the relevant art in Australia, the United States, or any other country on or before the priority date of the claims herein.

### SUMMARY OF THE INVENTION

In accordance with the present invention there is provided a sensor for detecting vibrations in a panel of an acoustic instrument. The sensor includes a brace means, for engaging the panel of the acoustic instrument, and a transducer associated with the brace means. The brace means detects vibrations in a region of the panel in engagement with the brace means and transmits the detected vibrations to the transducer. The transducer subsequently generates an electrical output signal representing vibrations detected by the transducer.

The brace means may include one or more brace members with the transducer being mounted on one of the brace members. In addition, each brace member may include a planar elongate surface for engaging the panel.

In one embodiment, the brace means includes a plurality of brace members. At least two of the brace members may be interconnected. In another embodiment, the interconnected brace members lie across one another, although this is not essential.

Each brace member may be made of relatively hard timber, aluminium, composite fibre or plastic to improve the ability of the brace members to detect and transmit vibrations detected to the transducer.

In an embodiment, the acoustic instrument is an acoustic guitar and the panel is the soundboard of the acoustic guitar.

It will be appreciated that a plurality of sensors may be employed with each sensor having one or more transducers on the brace means to enhance the performance of each sensor. In addition, one or more sensors may be employed on other panels besides the soundboard. For example, one or more sensors may be applied to the back panel of the acoustic guitar instead of the soundboard. Alternatively, sensors may be applied to both the soundboard and the back panel. Further, the one or more transducers used in the sensor of the present invention may be of any suitable type but are preferably of the type described in the inventors of earlier Australian patent no. 632064 (application no. 43019/89).

### BRIEF DESCRIPTION OF THE DRAWINGS

The embodiments of the present invention may be more completely understood in consideration of the following detailed description of various embodiments in connection with the accompanying drawings, in which:

FIG. 1 is a perspective view of a soundboard of an acoustic guitar with a sensor according to an embodiment of the present invention;

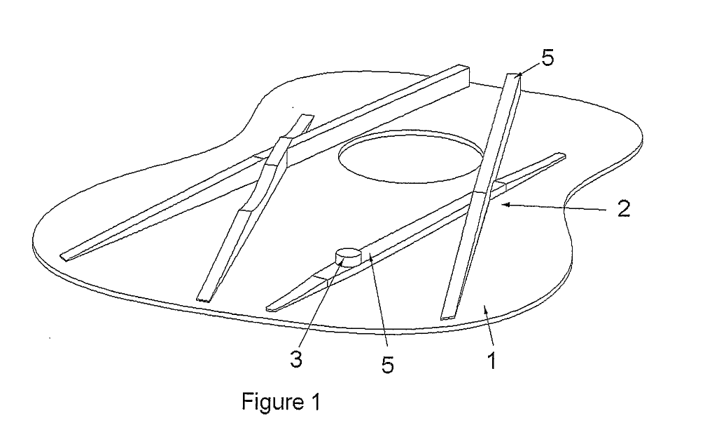

FIG. 2 is a perspective view of a soundboard of an acoustic guitar with a sensor according to an embodiment of the present invention;

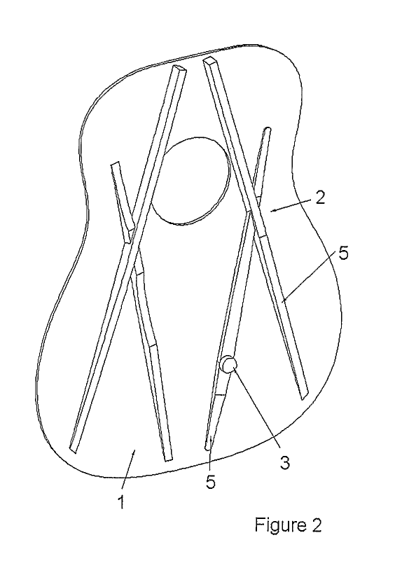

FIG. 3 is a perspective view of a soundboard of an acoustic guitar with a sensor according to an embodiment of the present invention; and

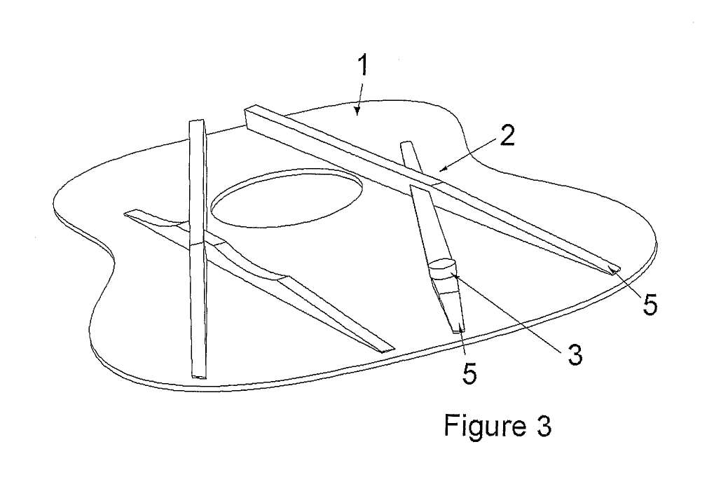

FIG. 4 is a side elevation view of a soundboard of an acoustic guitar with a sensor according to an embodiment of the present invention.

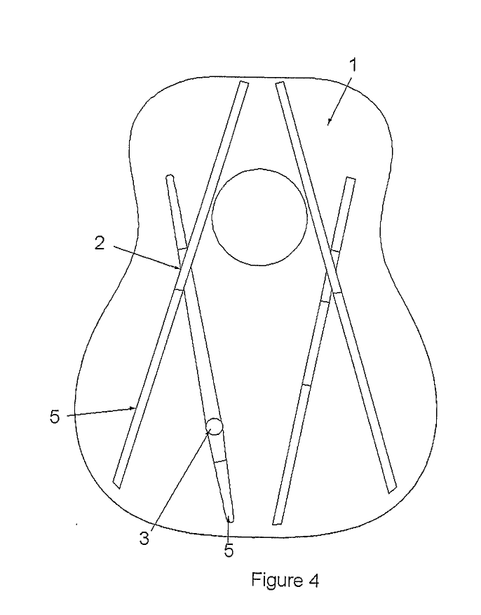

While the present invention is amenable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention.

### DESCRIPTION OF PREFERRED EMBODIMENT

With reference to the accompanying drawings there is shown a soundboard 1 of an acoustic guitar with a sensor mounted thereon for detecting vibrations in the soundboard 1. The sensor includes a brace means 2 for engaging the soundboard 1, and a transducer 3 mounted on the brace means 2. The transducer 3 generates an electrical output signal representing vibrations detected by the transducer 3. The electrical output signal may then be amplified and/or recorded.

The brace means 2 includes one or more brace members 5. The transducer 3 is mounted on one of the brace members 5. At least two of the brace members 5 are interconnected and intersect one another to provide a cross formation.

The brace members 5 are preferably made from a hard dense timber to improve the ability of the brace means 2 to detect and transmit the detected vibrations to the transducer 3. Each brace member 5 is substantially elongate and includes a planar elongate surface for engaging with the soundboard 1. The position of each brace member 5 with respect to the soundboard 1 may vary, however optimal performance of the sensor has been achieved by the brace members 5 extending at an angle to the direction of the grain of the timber of the soundboard 1. This positioning of the brace members 5 is also advantageous for achieving optimal structural rigidity.

It has also been found that the longer the brace member 5, the better the response provided by the sensor. This in turn enables a more realistic sound of an acoustic guitar to be produced by the amplification of the output electrical signal from the transducer 5.

Each brace member 5 is mounted to the soundboard 1 with a quality adhesive suitable for timber, for example PVC or formaldehyde based adhesives, cynoacrylates or epoxies. The transducer 3 can be accommodated on the brace member 5 at different positions with the transducer 3 generating different electrical output signals, representing vibrations detected by the transducer 3, at each position. It has been found however that locating the transducer 3 on a central region of the brace member 5 provides optimal performance of the sensor.

The width of each brace member 5, at least where the transducer 3 is mounted, is slightly wider than the transducer 3 such that the transducer 3 is fully supported by the brace member 5. In addition, to achieve better performance, the width of the brace member 5 is increased approaching the position on the brace member 5 where the transducer 3 is mounted. Further each brace member 5 preferably has a wide low profile as it has been found that high narrow profiles do not provide the sensor with the same level of performance.

Whilst high density timber is the preferred material for each brace member 5, other materials such as aluminium can be used.

The transducer 3 is secured to the brace member 5 by a nut and bolt assembly, for example an M4 countersunk cap screw and nut, such that the transducer 3 is securely clamped against the brace member 5. This enables the brace member 5 to more readily transmit the detected vibrations to the transducer 3.

In an alternative embodiment (not shown), the transducer 3 may be located within a recessed portion of the brace member 5 to thereby increase the surface area of the brace member 5 in contact with the transducer 3. This arrangement also enables the brace member 5 to more readily transmit the detected vibrations to the transducer 3.

In a further embodiment (not shown), the transducer 3 may be integral with the brace member 5, ie the transducer 3 and brace member 5 can be of a unitary construction.

In addition to the brace means 2 detecting and transmitting the detected vibrations to the transducer 3, the brace means 2 advantageously also provides structural rigidity to the sound board 1.

The sensor according to the present invention enables the transducer 3 to generate an electrical output signal more closely representing the vibrations in the soundboard 1. In addition, the brace members 5 enable a greater surface area of the soundboard 1 to be sampled by the sensor in comparison to a transducer mounted directly on the soundboard 1.

In one embodiment, the sensor of the present invention may be used in association with a guitar having a preamplifier and an under saddle sensor as described in WO 2005/001811, the contents of which are hereby incorporated herein by reference in their entirety. The under saddle sensor is mounted beneath a saddle of the guitar, and the sensor of the present invention is attached to a body portion of the guitar, such as the soundboard 1. The preamplifier includes a mixing device for combining the output of the under saddle sensor and the sensor attached to the soundboard 1.

The mixing device includes a first input, for receiving a signal from the under saddle sensor, and a second input, for receiving a signal from the sensor attached to the soundboard 1. The mixing device further includes a low pass filter, for passing signal components of the first input signal below a first frequency, and a high pass filter for passing signal components of the second input signal above a second frequency. The mixing device further includes a mixing circuit for combining the signals passed by the low pass filter and the high pass filter to form a combined output signal.

With this arrangement, the combination of (i) low frequencies from the under saddle sensor with (ii) higher frequencies from the sensor of the present invention attached to the soundboard produces a particularly preferred, or natural, representation of the sound of an acoustic guitar.

As the present invention may be embodied in several forms without departing from the essential characteristics of the invention, it should be understood that the above described embodiment should not be considered to limit the present invention but rather should be construed broadly. Various modifications and equivalent arrangements are intended to be included within the spirit and scope of the invention. Whilst the invention has been described in relation to an acoustic guitar it should not be considered as limiting the scope of the invention to only such an instrument. In this regard, the invention is also intended for other stringed musical instruments such as violins, cellos, etc.

1.-17. (canceled)

18. A sensor for detecting vibrations in a panel of an acoustic instrument, the sensor comprising:
a brace means for engaging the panel of the acoustic instrument; and
a transducer associated with the brace means;
wherein the brace means detects vibrations in a region of the panel in engagement with the brace means and transmits the detected vibrations to the transducer and the transducer generates an electrical output signal representing vibrations detected by the transducer.

19. The sensor of claim 18, wherein the brace means includes one or more brace members with the transducer being mounted on one of the brace members.

20. The sensor of claim 19, wherein each brace member includes a planar elongate surface for engaging the panel.

21. The sensor of claim 20, wherein the brace means includes a plurality of brace members and at least two of the brace members intersect.

22. The sensor of claim 19, wherein at least one of the brace members is made from a hard dense timber.

23. The sensor of claim 19, wherein at least one of the brace members is made of aluminium.

24. The sensor of claim 19, wherein the panel is made of timber and each brace member extends at an angle to a direction of grain of the panel.

25. The sensor of claim 19, wherein each brace member has a wide low profile.

26. The sensor of claim 19, wherein the transducer is mounted on a central region of one of the brace members.

27. The sensor of claim 26, wherein a width of the brace member increases where the transducer is mounted.

28. The sensor of claim 19, wherein the transducer is mounted in a recess in one of the brace members.

29. The sensor of claim 18, wherein the transducer is integral with the brace means.

30. The sensor of claim 18, wherein the acoustic instrument is an acoustic guitar and the panel is a soundboard of the acoustic guitar.

31. A stringed musical instrument comprising:
a first sensor mounted beneath a saddle of the instrument;
a second sensor attached to a panel of the stringed musical instrument; and
a pre-amplifier including a mixing device for combining outputs of the first and second sensors.

32. The stringed musical instrument of claim 31, wherein the second sensor includes a brace for engaging the panel of the stringed musical instrument.

33. The stringed musical instrument of claim 31, wherein the mixing device includes:
a first input for receiving a first input signal from the first sensor;
a second input for receiving a second input signal from the second sensor;
a low pass filter for passing signal components of the first input signal below a first frequency;
a high pass filter for passing signal components of the second input signal above a second frequency; and
a mixing circuit for combining the first and second input signals passed by the low pass filter and the high pass filter to form a combined output signal.

34. The stringed musical instrument of claim 31, wherein the stringed musical instrument is an acoustic guitar and the panel is a soundboard of the acoustic guitar.

35. An acoustic guitar comprising:
a panel; and
a sensor for detecting vibrations in the panel;
wherein the sensor includes a brace means for engaging the panel of the acoustic guitar and a transducer associated with the brace means, the brace means detects vibrations in a region of the panel in engagement with the brace means and transmits the detected vibrations to the transducer, and the transducer generates an electrical output signal representing vibrations detected by the transducer.

36. The acoustic guitar of claim 35, wherein the brace includes one or more brace members with the transducer being mounted on one of the brace members.

37. The acoustic guitar of claim 35, wherein the transducer is integral with the brace.

38. An acoustic guitar comprising:
a panel; and
a sensor for detecting vibrations in the panel;
wherein the sensor includes a brace engaged to the panel and a transducer associated with the brace, the brace detecting vibrations in a region of the panel in engagement with the brace and transmitting the detected vibrations to the transducer, the transducer generating an electrical output signal representing vibrations detected by the transducer.

39. A sensor for detecting vibrations in a panel of an acoustic instrument, the sensor comprising:
a brace engaged with the panel of the acoustic instrument; and
a transducer associated with the brace;
wherein the brace detects vibrations in a region of the panel in engagement with the brace and transmits the detected vibrations to the transducer and the transducer generates an electrical output signal representing vibrations detected by the transducer.

40. The sensor of claim 39, wherein the brace includes one or more brace members with the transducer being mounted on one of the brace members.

41. The sensor of claim 39, wherein the transducer is integral with the brace.
